(19) United States
(12) Patent Application Publication
(10) Pub. No.: US 2009/0290072 A1
(43) Pub. Date: Nov. 26, 2009

(54) REMOTE CONTROLLER, ELECTRONIC DEVICE AND CONTROL METHOD THEREOF

(75) Inventor: Chang-jin LEE, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/406,989

(22) Filed: Mar. 19, 2009

(30) Foreign Application Priority Data
May 22, 2008 (KR) 10-2008-0047475

(51) Int. Cl. H04N 5/44; H04L 17/02; H04B 10/00

(52) U.S. Cl. 348/734; 341/176; 398/106; 348/E05.096

(57) ABSTRACT

A remote controller of controlling an electronic device, the remote controller includes: an input unit; a communication unit which communicates with at least one electronic device to receive an identification code of the electronic device if a condition for receiving the identification code is satisfied, and a remote-controller controller which stores the identification code received from the electronic device, and selects the stored identification code so that the electronic device corresponding to the selected identification code is controlled through the input unit.

### CROSS-REFERENCE TO RELATED APPLICATION

This application claims priority from Korean Patent Application No. 10-2008-0047475, filed on May 22, 2008 in the Korean Intellectual Property Office, the disclosure of which is incorporated herein by reference.

### BACKGROUND OF INVENTION

1. Field of Invention

Apparatuses and methods consistent with the present invention relate to a remote controller, an electronic device to be controlled by the remote controller, and a control method thereof, and more particularly to a remote controller, an electronic device, and a control method thereof, in which at least one electronic device is easily registered and controlled.

2. Description of the Related Art

A remote controller enables a user to remotely control various operations of an electronic device, and in general, is individually configured to model characteristics of a corresponding electronic device.

With the development of electronic technology, the number of types of electronic devices, such as televisions and audio/video reproducing devices, has increased. As the number of electronic devices increases, the number of remote controllers used to control the electric devices also increases. Thus, to control an electronic device, it is inconvenient for a user to find a corresponding remote controller among many remote controllers. Further, the remote controllers is likely to be lost by a user as they increases in number.

To solve these problems, there has been proposed a universal remote controller capable of controlling a plurality of electronic devices

The universal remote controller is provided with a manual that describes a registration code corresponding to each electronic device. To control an electronic device with this universal remote controller, a user needs to register the electronic device by finding a code corresponding to the electronic device from the manual and then manipulating buttons of the remote controller to input the code.

However, such a conventional universal remote controller is inconvenient for a user since he/she has to input the codes one by one. Further, because the codes are set according to models of the electronic device, it is difficult for the conventional universal remote controller to differentiate between the electronic devices if there are plural electronic devices of the same model.

Also, the manual with the registration code is likely to be lost since it is kept by a user. If the manual is lost and a user does not know the codes corresponding to the electronic devices, it is impossible to register the electronic device in the remote controller, so that the remote controller cannot control the electronic device.

### SUMMARY OF THE INVENTION

Accordingly, the present invention provides a remote controller, an electronic device, and a control method thereof, in which a user can easily store codes without directly finding and inputting the codes one by one in order to control a plurality of electronic devices through one remote controller.

The present invention also provides a remote controller, an electronic device, and a control method thereof, in which codes can be stored without a manual that describes the codes.

The present invention also provides a remote controller capable of differentiating electronic devices even if there are plural electronic devices of the same model, the electronic device and a control method thereof.

According to an aspect of the present invention, there is provided a remote controller of controlling an electronic device, the remote controller including: a user input unit; a remote-controller communication unit which communicates with at least one electronic device having an identification code; and a remote-controller controller which receives and stores the identification code from the electronic device if a condition for receiving the identification code is satisfied, and selects the stored identification code so that the electronic device corresponding to the selected identification code is controlled through the user input unit.

The remote-controller controller may receive and store the identification codes from a plurality of electronic devices, respectively, and selects one among a plurality of stored identification codes.

The user input unit may select one among the plural electronic devices corresponding to the plural stored identification codes, and the remote-controller controller may control the electronic device selected by the user input unit.

The identification code may include a Media Access Control (MAC) address of the electronic device.

The remote-controller controller may determine a model of the electronic device corresponding to the MAC address on the basis of the received MAC address.

The identification code further includes model information of the electronic device.

The communication between the remote-controller communication unit and the electronic device may be based on a radio frequency (RF) method.

The condition for receiving the identification code may be satisfied when a preset input for receiving the identification code is performed through the user input unit.

The condition for receiving the identification code may be satisfied when the remote-controller controller senses that the electronic device outputs a signal having intensity of a preset level or higher.

The remote controller further includes a remote-controller infrared communication unit to transmit an infrared signal to the electronic device, wherein the remote-controller controller transmits a requesting signal for the identification code to the electronic device through the remote-controller infrared communication unit, and receives the identification code corresponding to the requesting signal.

The remote-controller controller may transmit a requesting signal for the identification code through the remote-controller communication unit, and receives the identification code from at least one electronic device that receives the requesting signal.

The remote controller further includes a display unit to display that the identification code is received and stored.

The remote-controller controller may set an identification name corresponding to the identification code of the electronic device, and controls the display unit to display the identification name when the electronic device is selected by the user input unit.

The remote-controller controller may control the display unit to display a message so that the identification name is set when receiving the identification code, and stores the identification name set through the user input unit.

If plural identification codes may be stored corresponding to the electronic devices of the same model and one of the plural identification codes is selected, the remote-controller controller controls the display unit to display the selected identification code differentially from other identification codes.

According to another aspect of the present invention, there is provided a control method of a remote controller that controls an electronic device, the method including: receiving and storing an identification code from the electronic device if a condition for receiving the identification code is satisfied with regard to at least one electronic device having the identification code; and selecting the stored identification code and controlling the electronic device corresponding to the selected identification code.

The receiving the identification code may include receiving the identification codes from a plurality of electronic devices, respectively, and the controlling the electronic device may include selecting one among the plurality of stored identification codes.

The receiving the identification code may include receiving an MAC address of the electronic device.

The receiving the identification code may include determining a model of the electronic device corresponding to the MAC address on the basis of the received MAC address.

The receiving the identification code further includes receiving model information of the electronic device.

The communication between the remote controller and the electronic device may be based on an RF method.

The remote controller may include a user input unit, and the receiving the identification code may include: performing a preset input for receiving the identification code through the user input unit; and receiving the identification code from the electronic device in response to the preset input.

The receiving the identification code may include: determining whether a signal having intensity of a preset level or higher; and receiving the identification code from the electronic device if the intensity of the signal is higher than the preset level.

The receiving the identification code may include: transmitting a requesting signal for the identification code; and receiving the identification code corresponding to the requesting signal from at least one electronic device.

The transmitting the requesting signal for the identification code may include transmitting an infrared signal for requesting the identification code.

The transmitting the requesting signal for the identification code may include transmitting the requesting signal in a radio frequency (RF) method.

The receiving the identification code further includes displaying that the identification code is received and stored.

The receiving the identification code further includes setting an identification name corresponding to the received and stored identification code, and the controlling the electronic device further includes displaying the identification name when the stored identification code is selected.

The remote controller may include a user input unit, and the setting the identification name may include inputting the identification name through the user input unit.

If plural identification codes may be stored corresponding to the electronic devices of the same model and one of the plural identification codes is selected, the controlling the electronic device further includes displaying the selected identification code differentially from other identification codes.

According to another aspect of the present invention, there is provided an electronic device to be controlled by a remote controller that outputs a control signal, the electronic device including: a communication unit which communicates with the remote controller; and a controller which transmits the identification code to be stored in the remote controller if a preset condition for transmitting the identification code from the electronic device to the remote controller is satisfied, and controls the electronic device on the basis of the control signal output from the remote controller corresponding to the identification code.

The electronic device may be provided in plural, and each controller of the plural electronic devices may transmit the identification code to the remote controller.

The identification code may include an MAC address of the communication unit.

The identification code further includes model information of the electronic device.

The communication between the communication unit and the remote controller may be based on an RF method.

The electronic device further includes a menu button for setting the controller to transmit the identification code, wherein the condition for transmitting the identification code is satisfied when a preset input for transmitting the identification code is performed through the menu button.

The electronic device further includes an infrared communication unit to receive an infrared signal from the remote controller, wherein the controller transmits the identification code to the remote controller when receiving the infrared signal for requesting the identification code.

The controller may transmit the identification code to the remote controller when receiving a requesting signal for the identification code from the remote controller through the communication unit.

The electronic device may include at least one of a television, a monitor, a set-top box, a video cassette recorder (VCR), a digital versatile disc (DVD) player, a Blu-ray disc player, and an audio device.

The foregoing and/or other aspects of the present invention can be achieved by providing a method of controlling an electronic device to be controlled by a remote controller that outputs a control signal, the method including: transmitting the identification code to be stored in the remote controller if a preset condition for transmitting the identification code from the electronic device to the remote controller is satisfied; and controlling the electronic device on the basis of the control signal output from the remote controller corresponding to the identification code.

The electronic device may be provided in plural, and the transmitting the identification code may include transmitting the identification codes from the plural electronic devices to the remote controller.

The transmitting the identification code may include transmitting an MAC address of the electronic device to the remote controller.

The transmitting the identification code may include transmitting model information of the electronic device.

The communication between the electronic device and the remote controller may be based on an RF method.

The transmitting the identification code further includes setting the identification code to be transmitted to the remote controller through a menu button provided in the electronic device.

The transmitting the identification code may include: receiving a requesting signal for the identification code; and transmitting the identification code to the remote controller that transmitting the requesting signal.

The requesting signal for the identification code may include an infrared signal.

The requesting signal for the identification code may include a signal based on an RF method.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a block diagram of a remote controller and an electronic device according to a first exemplary embodiment of the present invention;

FIG. 2 is a control flowchart of the remote controller according to the first exemplary embodiment of the present invention;

FIG. 3 is a control flowchart of the electronic device according to the first exemplary embodiment of the present invention;

FIG. 4 is a control flowchart of a remote controller according to a second exemplary embodiment of the present invention;

FIG. 5 is a control flowchart of a remote controller according to a third exemplary embodiment of the present invention;

FIG. 6 is a block diagram of a remote controller and an electronic device according to a fourth exemplary embodiment of the present invention;

FIG. 7 is a control flowchart of the remote controller according to the fourth exemplary embodiment of the present invention;

FIG. 8 is a control flowchart of the electronic device according to the fourth exemplary embodiment of the present invention;

FIG. 9 is a control flowchart of a remote controller according to a fifth exemplary embodiment of the present invention; and

FIG. 10 is a control flowchart of an electronic device according to the fifth exemplary embodiment of the present invention.

### DETAILED DESCRIPTION OF EXEMPLARY EMBODIMENTS OF THE INVENTION

Below, exemplary embodiments of the present invention will be described in detail with reference to accompanying drawings so as to be easily realized by a person having ordinary knowledge in the art. The present invention may be embodied in various forms without being limited to the exemplary embodiments set forth herein. Descriptions of well-known parts are omitted for clarity, and like reference numerals refer to like elements throughout.

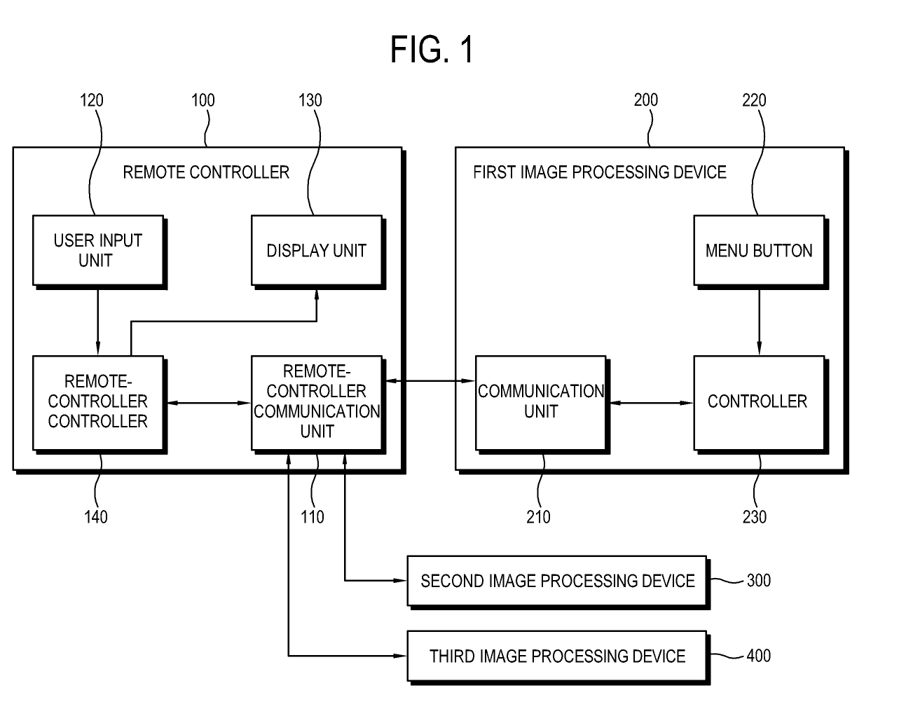

FIG. 1 is a block diagram of a remote controller 100 and an electronic device according to a first exemplary embodiment of the present invention.

The electronic device includes various devices such as an audio device, etc. as well as an image processing device such as a television, a monitor, a set-top box, a VCR, a DVD player, a Blu-ray disc player or the like. According to the first exemplary embodiment, three image processing devices 200, 300 and 400 are used as an example of the electronic device. However, the present invention is not limited to the kind or the number of electronic device. Hereinafter, the image processing devices 200, 300 and 400 will be described as the electronic device.

As shown in FIG. 1, with regard to the image processing devices 200, 300 and 400, the remote controller 100 receives and stores identification codes from the image processing devices 200, 300 and 400, respectively. Further, the remote controller 100 selects an identification code among the plural stored identification codes, and controls operations of the image processing device 200, 300 or 400 corresponding to the selected identification code.

Here, each image processing device 200, 300, 400 may have an MAC address of a communication unit 210 (to be described later) as its own identification code. The MAC address is an inherent hardware address of the communication unit 210 of the image processing device 200, 300, 400. The MAC address is numerically varied according to the communication unit 210.

However, the identification codes of the image processing device 200, 300 and 400 are not limited to the MAC address. Alternatively, while manufacturing the image processing devices 200, 300 and 400, identification codes may be provided to the respective image processing devices 200, 300 and 400 according to predetermined conditions. For reference, if the MAC address is employed as the identification code, it is not necessary to separately provide the identification codes to the image processing devices 200, 300 and 400.

An RF method is used for bi-directional communication between the remote controller 100 and each image processing device 200, 300, 400. The identification codes of the image processing devices 200, 300 and 400 are transmitted to the remote controller 100 from the image processing devices 200, 300 and 400, so that the remote controller 100 can select one of the image processing devices 200, 300 and 400 corresponding to the identification codes, thereby controlling operations of the image processing devices 200, 300 and 400.

Detailed configurations of the remote controller 100 will be described below.

The remote controller 100 includes a remote-controller communication unit 110 which communicates with the image processing devices 200, 300 and 400; a user input unit 120 which is manipulated by a user; a display unit 130 which displays an operating state of the remote controller 100; and a remote-controller controller 140 which controls the remote-controller communication unit 110, the user input unit 120, and the display unit 130.

The remote-controller communication unit 110 enables the remote controller 100 to bi-directionally communicate with the image processing devices 200, 300 and 400 in a predetermined frequency band according to the RF method. The remote-controller communication unit 110 receives the identification codes from the image processing devices 200, 300 and 400, and sends them to the remote-controller controller 140. Further, the remote-controller communication unit 110 transmits a control signal corresponding to manipulation generated in the user input unit 120 to the image processing devices 200, 300 and 400 under control of the remote-controller controller 140.

The remote-controller controller 140 selects one of the plural identification codes, and controls the remote-controller communication unit 110 to transmit the control signal to the image processing devices 200, 300 and 400 corresponding to the selected identification code, so that a user can control the operation of the image processing devices 200, 300 and 400.

The user input unit 120 includes a plurality of keys or buttons. The buttons corresponds to various functions for controlling the operation of the remote controller 100 itself or the operation of the image processing devices 200, 300 and 400.

The user input unit 120 sends the remote-controller controller 140 an input signal corresponding to a button pressed by a user. Based on the input signal from the user input unit 120, the remote-controller controller 140 generates the control signal to be transmitted by the remote-controller communication unit 110.

The user input unit 120 may be provided to receive a preset input from a user, so that the remote controller 100 can receive the identification code from the image processing devices 200, 300 and 400. For example, the user input unit 120 may include a predetermined button (not shown), and the remote controller 100 may receive the identification codes when the button is pressed once or for a predetermined time or more.

The user input unit 120 allows a user to select one of the image processing devices 200, 300 and 400, each having an identification code which is stored in the remote controller 100. If a user selects one of the image processing devices 200, 300 and 400 through the user input unit 120, the remote-controller controller 140 selects the identification code corresponding to the selected image processing devices 200, 300 and 400. Thus, a user can control the image processing device 200, 300, 400 corresponding to the selected identification code through the remote controller 100. There may be various methods of selecting one among the image processing devices 200, 300 and 400 to be controlled through the user input unit 120. For example, a switching button (not shown) may be provided so that the image processing devices 200, 300, 400 can be alternately switched each time a user presses the switching button.

The display unit 130 displays an operating state of the remote controller 100 or an operating state of the image processing device 200, 300, 400 currently controlled by the remote controller 100. To this end, the display unit 130 may be a liquid crystal display (LCD), a light emitting diode (LED), an organic light emitting diode (OLED), etc. and displays the operating state as a letter, an icon or a symbol.

The remote-controller controller 140 receives the identification codes from the image processing devices 200, 300, and 400 when the input signal for receiving the identification codes from the image processing devices 200, 300 and 400 is generated through the user input unit 120. The remote-controller controller 140 includes a memory (not shown), and stores the received identification codes in the memory if the received identification codes are not previously stored in the memory.

In this exemplary embodiment, the remote-controller controller 140 receives the identification code that includes the MAC address. The remote-controller controller 140 includes the memory (not shown) which stores a table having model information of the image processing devices 200, 300 and 400 corresponding to predetermined MAC addresses. In response to receiving the MAC address, the remote-controller controller 140 retrieves the table in the memory, and determines the model information of the image processing devices 200, 300 and 400 corresponding to the received MAC addresses. Thus, the remote-controller controller 140 generates the control signal corresponding to each model of the image processing devices 200, 300 and 400, and transmits the control signal to the corresponding image processing devices 200, 300 and 400.

However, the present invention is not limited to the foregoing exemplary embodiment and may have various changes in design. For example, the identification code received by the remote controller 100 may contain the model information of the image processing devices 200, 300 and 400 together with the MAC address. In this case, the remote-controller controller 140 may determine the model information of the image processing devices 200, 300 and 400 through the received MAC address.

The remote-controller controller 140 receives and stores the identification codes from the image processing devices 200, 300 and 400, respectively. Further, the remote-controller controller 140 selects an identification code among the stored identification codes, so that a user can control the image processing device 200, 300, 400 corresponding to the selected identification code through the user input unit 120.

If an input signal for controlling the operation of the image processing device 200, 300, 400 is received through the user input unit 120 after selecting the identification code among the identification codes, the remote-controller controller 140 converts the input signal into the control signal and transmits it to the image processing device 200, 300, 400 having the selected identification code through the remote-controller communication unit 110. Accordingly, a user can control the operations of the image processing device 200, 300, 400 concerned, through the remote controller 100.

If there are image processing devices 200, 300 and 400 of the same model among the selectable identification codes, the remote-controller controller 140 may differentiate the image processing devices 200, 300 and 400 when selecting the identification code and make the display unit 130 display them. That is, if there are plural identification codes corresponding to the image processing devices 200, 300 and 400 of the same model, the remote-controller controller 140 controls the display unit 130 to display them so that the selected identification code can be differentiated from other identification codes.

For example, in the case that the first image processing device 200 and the second image processing device 300 are the same model television. If the identification code of the first image processing device 200 is selected, the remote-controller controller 140 controls the display unit 130 made of an LCD panel to display a message of “first television.” Further, if the identification code of the second image processing device 300 is selected, the remote-controller controller 140 controls the display unit 130 to display a message of “second television” so that it can be differentiated from the first image processing device 200. Accordingly, a user can easily differentiate the image processing devices 200, 300 and 400 to be controlled by the remote controller 100 from one another even if two or more of the image processing devices 200, 300 and 400 are the same model.

Further, the remote controller 140 may receive control-key setting data or control-key arrange information corresponding to the image processing devices 200, 300 and 400 together with the identification code. Thus, when one among the image processing devices 200, 300 and 400 is selected to be controlled, the remote controller 140 may generate the control signal corresponding to the control-key information of the selected image processing device 200, 300 and 400.

Below, configurations of the image processing devices 200, 300 and 400 will be described. In this exemplary embodiment, the configuration of the image processing device 200 will be representatively described, and repetitive descriptions of the second and third image processing devices 300 and 400 will be omitted. Here, each image processing device may be realized as a television, a monitor, a set-top box, a VCR, a DVD player, a Blu-ray disc player or the like.

The first image processing device 200 includes the communication unit 210 which communicates with the remote controller 100, a menu button 220 which is provided in the first image processing device 200, and a controller 230 which controls the first image processing device 200 based on the control signal received from the remote controller 100 via the communication unit 210.

The communication unit 210 bi-directionally communicates with the remote-controller communication unit 110 under the control of the controller 230. Here, the communication unit 210 uses the RF method like the remote-controller communication unit 110, and therefore the bi-directional communication between the remote controller 100 and the first image processing device 200 is possible.

The communication unit 210 has an MAC address used as the identification code in the present exemplary embodiment. The MAC address, which is an inherent hardware address of the communication unit 210, allows the remote controller 100 to determine the address of the communication unit 210 in the RF method. In other words, the remote-controller controller 140 selects the MAC address of the communication unit 210, so that the control signal can be transmitted to the communication unit 210 of the controller 230.

Although the image processing devices 200, 300 and 400 are of the same model, the communication units 210 have different MAC addresses. For example, although the first image processing device 200 and the second image processing device 300 are the same model television, they have different MAC addresses, so that the remote-controller controller 140 can differentiate the first image processing device 200 and the second image processing device 300 from each other.

The menu button 220 may be provided on a casing (not shown) of the first image processing device 200, and transmits the input signal corresponding to the manipulation of a user to the controller 230. Through the menu button 220, a user may control at least one of the operations of the first image processing device 200, which are controllable by the remote controller 100.

In response to manipulation of the menu button 220, the identification code of the first image processing device 200 is stored in the remote controller 100, and the identification code is transmitted from the first image processing device 200 to the remote controller 100. This is carried out as a user applies a preset manipulation to the menu button 220, and thus the controller 230 transmits the identification code of the first image processing device 200, i.e., the MAC address of the communication unit 210 to the remote controller 100.

If a preset condition for transmitting the identification code of the first image processing device 200 to the remote controller 100 is satisfied, the controller 230 transmits the identification code to the remote controller 100. Specifically, according to the present exemplary embodiment, the controller 230 controls the communication unit 210 to transmit the MAC address to the remote in response to receiving the input signal, which is given for transmitting the identification code, from the menu button 220. Accordingly, the remote controller 100 may receive and store the MAC address. If necessary, the controller 230 may transmit the control-key setting data, the control-key arrange information or the like of the remote controller 100 corresponding to the first image processing device 200, and the model information of the first image processing device 200, together with the MAC address.

The controller 230 determines whether the control signal is output from the remote controller 100 corresponding to the identification code of the first image processing device 200 when receiving the control signal from the remote controller 100 through the communication unit 210. The controller 230 controls the first image processing device 200 to operate based on the control signal if it determined that the control signal corresponding to the identification code of the first image processing device 200 is output.

The determination method of the controller 230 may have various changes in design. For example, in the state that the identification code of the first image processing device 200 is selected, the remote controller 100 outputs the control signal containing the selected identification code in a header thereof. If the communication unit 210 receives this control signal, the controller 230 retrieves the header of the control signal and determines whether the extracted identification code corresponds to that of the first image processing device 200, thereby performing the foregoing determination. However, other methods may be employed.

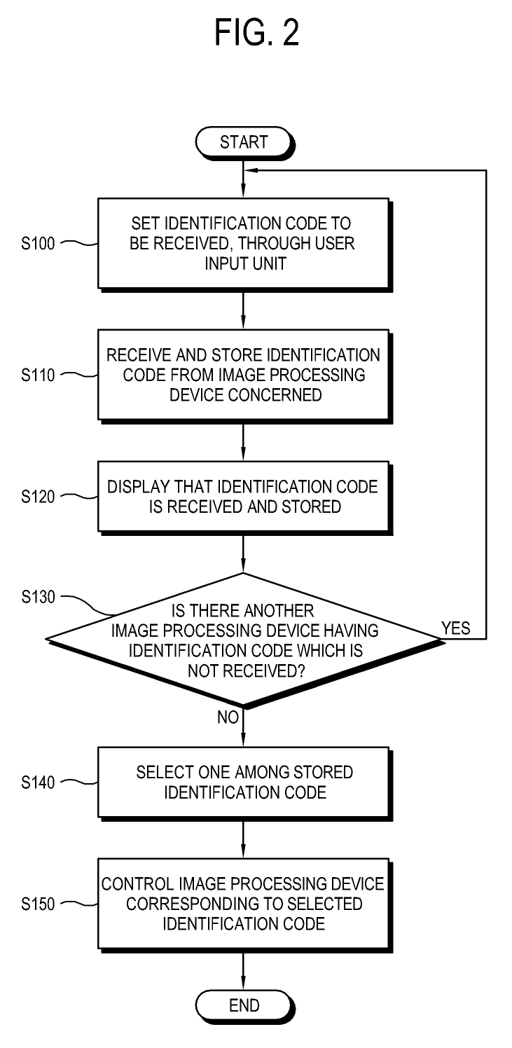

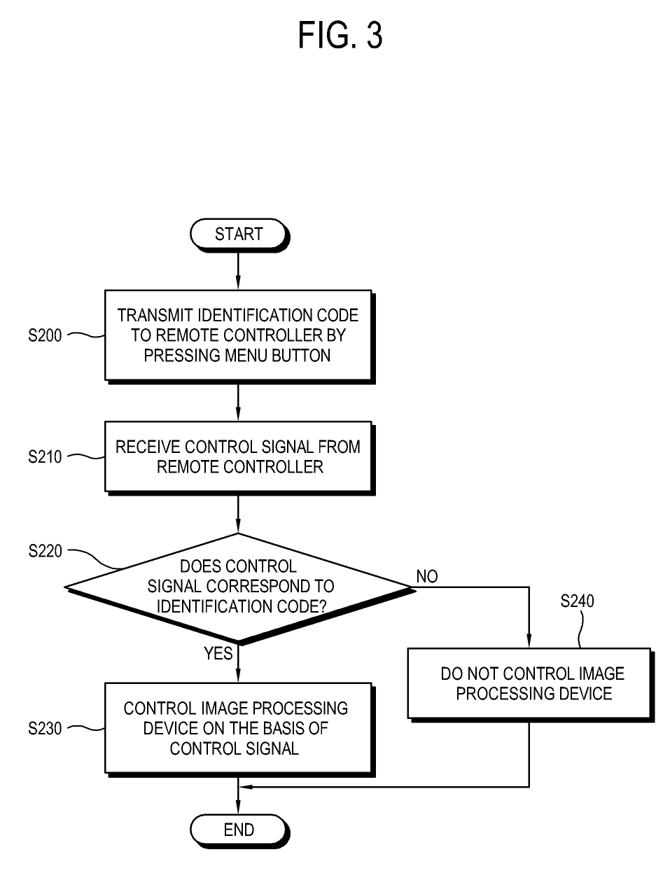

With this configuration, a method of controlling the remote controller 100 and the image processing devices 200, 300 and 400 will be described with reference to FIGS. 2 and 3. Here, the remote controller 100 is in a default state in which the identification codes of the image processing devices 200, 300 and 400 are not previously stored.

FIG. 2 is a control flowchart of the remote controller according to the first exemplary embodiment of the present invention.

As shown in FIG. 2, the method of controlling the remote controller 100 according to the first exemplary embodiment includes operations S100˜S130 of receiving and storing the identification codes from the image processing devices 200, 300 and 400, respectively, if a condition for receiving the identification codes with regard to the image processing devices 200, 300 and 400 is satisfied; and operations S140 to S150 of selecting one among the stored identification codes and controlling the image processing device 200, 300, 400 corresponding to the selected identification code. Detailed descriptions of the operations are provided as follows.

At operation S100, a user applies a previously set input, which allows the remote controller 100 to receive the identification code, to the user input unit 120 in order to first store the identification code of the first image processing device 200 in the remote controller 100. At operation S110, the remote-controller controller 140 receives and stores the identification code from the first image processing device 200 through the remote-controller communication unit 110 in response to the input signal from the user input unit 120.

At operation S120, the remote-controller controller 140 controls the display unit 130 to display a message of informing a user that the identification code is received and stored. Thus, a user can be informed that the identification code is stored in the remote controller 100.

At operation S130, it is checked whether there is another image processing device having an identification code which has not been received. If necessary, the foregoing processes are repeated until the remote controller 100 receives and stores the identification codes from the second and third image processing devices 300 and 400.

Thus, the image processing devices 200, 300 and 400 can be controlled by the remote controller 100 after the identification codes from the image processing devices 200, 300 and 400 are stored.

At operation S140, a user selects one among the image processing devices 200, 300 and 400 through the user input unit 120, and the remote-controller controller 140 selects the identification code corresponding to the selection in the user input unit 120 among the stored identification codes. At operation S150, the remote-controller controller 140 transmits the control signal to the image processing device 200, 300, 400, so that the remote controller 100 can control the image processing device 200, 300, 400 corresponding to the selected identification code.

For example, if a user selects the first image processing device 200 to be controlled through the user input unit 120, the remote-controller controller 140 selects the identification code of the first image processing device 200 among the stored identification codes. Further, when the input signal for controlling the first image processing device 200 is received through the user input unit 120, the remote-controller controller 140 converts the input signal into the control signal and transmits the control signal to the first image processing device 200 corresponding to the selected identification code through the remote-controller communication unit 110. Accordingly, a user can control the first image processing device 200 through the remote controller 100.

FIG. 3 is a control flowchart of the electronic device 200, 300, 400 according to the first exemplary embodiment of the present invention.

As shown in FIG. 3, the method of controlling the electronic device 200, 300, 400 according to the first exemplary embodiment includes an operation S200 of transmitting the identification codes to the remote controller 100 if a preset condition for transmitting the identification code to the remote controller 100 is satisfied; and operations S210 through S240 of controlling the operations of the image processing device 200, 300, 400 based on the basis of the control signal output from the remote controller 100 depending on the identification code. Detailed descriptions of the operations with regard to the first image processing device 200 are provided as follows by way of example.

At operation S200, a user applies a preset input, such as pressing the menu button 220 or the like, to transmit the identification code from the first image processing device 200 to the remote controller 100, and in response, the controller 230 transmits the identification code of the first image processing device 200 to the remote controller 100.

These operations are also performed in the second image processing device 300 and the third image processing device 400, so that the remote controller 100 stores the identification codes of the image processing devices 200, 300 and 400. Thus, the remote controller 100 can select one among the stored identification codes and transmit the control signal to the electronic device 200, 300, 400 corresponding to the selected identification code.

At operation S210, the communication unit 210 receives the control signal from the remote controller 100. At operation S220 the controller 230 determines whether the control signal corresponds to the identification code transmitted at operation S200, i.e., corresponds to the identification code of the first image processing device 200.

If it is determined that the received control signal corresponds to the identification code of the first image processing device 200, the controller 230 controls the operations of the first image processing device 200 based on the control signal at the operation S230.

On the other hand, if it is determined that the received control signal does not correspond to the identification code of the first image processing device 200, i.e., corresponds to the identification code of the second image processing device 300 or third image processing device 400, the controller 230 does not control the operations of the first image processing device 200 based on control signal at operation S240.

Thus, the image processing devices 200, 300 and 400 have their own identification codes, respectively, and the identification codes of the image processing devices 200, 300 and 400 are transmitted to the remote controller 100 under the previously set condition. The remote controller 100 stores the respective identification codes, and selects one of them, thereby controlling the operation of the image processing device 200, 300 and 400 corresponding to the selected identification code.

In the first exemplary embodiment, the remote controller 100 receives the identification codes from the image processing devices 200, 300 and 400 when there is a preset input through the user input unit 120. However, the present invention is not limited thereto.

Another method of the remote controller 100 to receive the identification code according to a second exemplary embodiment will be described below.

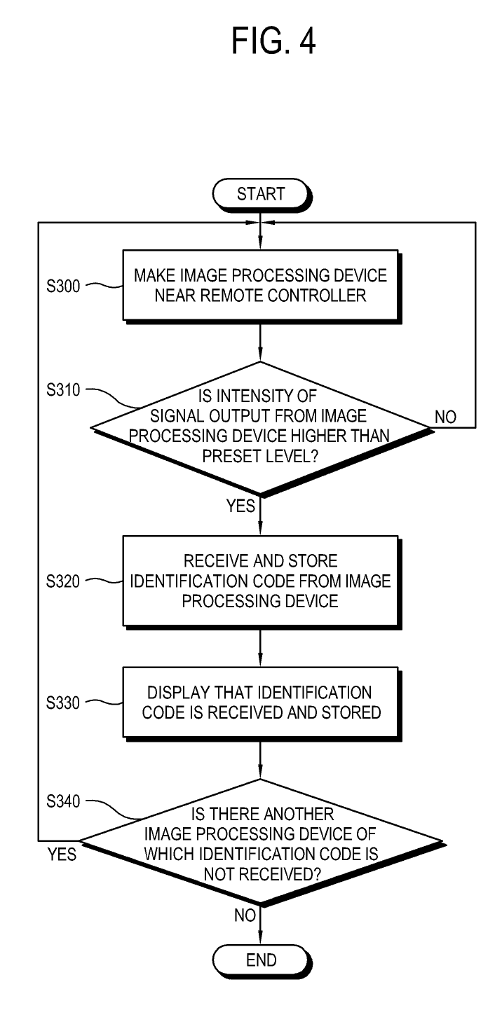

FIG. 4 is a control flowchart of a remote controller according to the second exemplary embodiment of the present invention.

As shown in FIG. 4, a remote controller 100 according to the second exemplary embodiment of the present invention automatically receives and stores the identification codes from the image processing devices 200, 300 and 400 if the image processing devices 200, 300 and 400 output signals each having intensity of a preset level or higher. Below, it will be described by way of example that the remote controller 100 receives the identification codes from the first image processing device 200. Detailed descriptions of the operations of receiving the identification codes are provided as follows.

At operation S300, a user places the remote controller 100 near the first image processing device 200. The nearer the remote controller 100 is placed to the first image processing device 200, the stronger the intensity of the output signal received from the image processing device 200. At operation S310, the remote-controller controller 140 senses the intensity of the signal through the remote-controller communication unit 110, and determines whether the intensity of the sensed output signal is the preset level or higher.

If it is determined that the intensity of the output signal from the first image processing device 200 is the preset level or higher, the remote-controller controller 140 receives the identification code from the first image processing device 200 and stores the received identification code at operation S320. Then, at operation S330, the remote-controller controller 140 controls the display unit 130 to display a message that the identification code of the first image processing device 200 is received and stored.

Further, at operation S340 it is checked whether there is another image processing device having an identification code has not been previously received. Then, if necessary, the foregoing processes are repeated until the remote controller 100 receives and stores the identification codes from the second and third image processing devices 300 and 400.

In such a manner, the remote controller 100 can receive and store the identification codes of the image processing devices 200, 300 and 400 even though a user does not manipulate the user input unit 120.

After the remote controller 100 receives the identification codes from the image processing devices 200, 300 and 400, identification names corresponding to the identification codes may be set, which will be described below as a third exemplary embodiment.

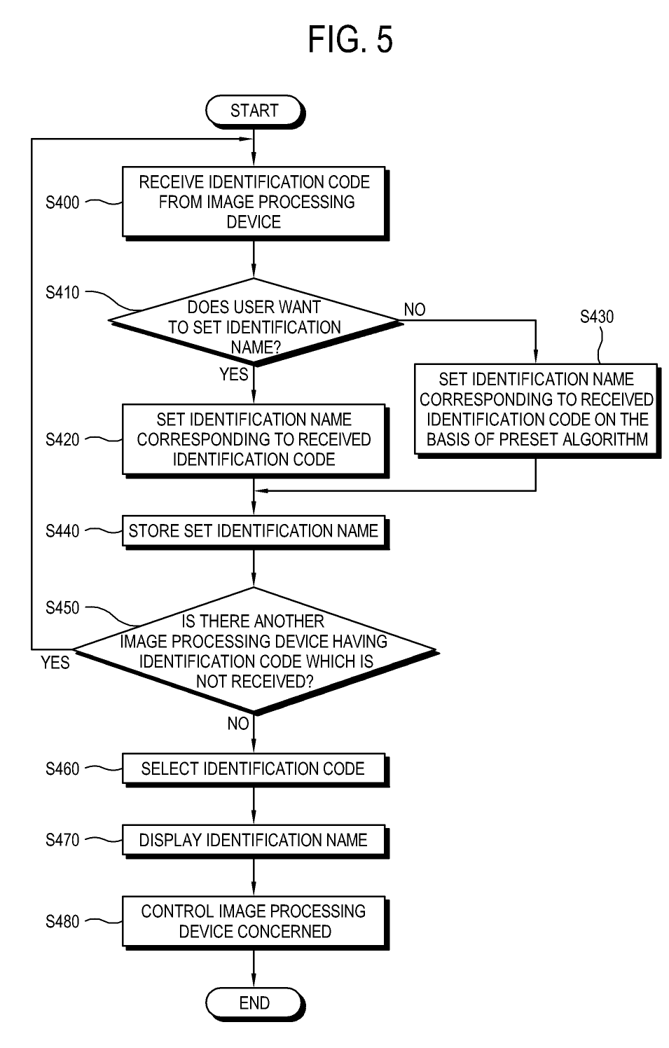

FIG. 5 is a control flowchart of a remote controller 100 according to the third exemplary embodiment of the present invention.

As shown in FIG. 5, a remote controller 100 according to the third exemplary embodiment of the present invention sets identification names corresponding to the identification codes when receiving and storing the identification codes from the image processing devices 200, 300 and 400. Then, the remote controller 100 displays the identification names corresponding to the selected identification codes on the display unit 130 when selecting one among the stored identification codes, thereby allowing a user to easily know which one of the image processing devices 200, 300 and 400 is currently selected.

The identification names may be automatically set by an algorithm previously set in the remote controller 100, when receiving the identification codes. Otherwise, the identification names corresponding to the identification codes may be set through the user input unit 120, when receiving the identification codes.

Below, detailed operations of the third exemplary embodiment will be described by way of example with respect to the remote controller 100 and the first image processing device 200.

At operation S400, the remote controller 100 receives the identification code from the first image processing device 200. At operation S410, the remote-controller controller 140 selects whether to allow a user to set the identification names corresponding to the received identification codes. This may be implemented by making the remote-controller controller 140 display an optional message and by a user's selection through the optional message.

In the case that a user directly sets the identification names, at operation S420 a user uses the user input unit 120 to set the identification names corresponding to the received identification codes. Without limitation, the identification names may be freely set by combination of numerals, letters, characters, etc. that a user can easily know. For example, “TV_{—}01”, “Set-top”, “TV_{—}02”, etc. may be set as the identification names.

In the case that a user does not set the identification names, the remote-controller controller 140 sets the identification names based on the preset algorithm at operation S430. For example, the identification names may be set as “Device_{—}01”, “Device_{—}02”, “Device_{—}03”, and so on according to setting sequences.

At operation S440, the remote-controller controller 140 stores the identification names which are set.

At operation S450, it is checked whether there is another image processing device having an the identification code which has not been received. Then, if necessary, the foregoing processes are repeated until the remote controller 100 stores the identification codes and the identification names from the second and third image processing devices 300 and 400.

If a user selects one among the image processing devices 200, 300 and 400 through the user input unit 120, at operation S460 the remote-controller controller 140 selects the identification code corresponding to the selection. At operation S470, the remote-controller controller 140 displays the identification name corresponding to the selected identification code on the display unit 130. At operation S480, a user checks the identification name and controls operations of the corresponding image processing device 200, 300, 400.

Accordingly, the identification names that a user can easily know are given corresponding to the identification codes while receiving and storing the identification codes, and the identification name concerned is displayed when selecting the identification code, so that a user can easily know which one of the image processing devices 200, 300 and 400 is currently selected.

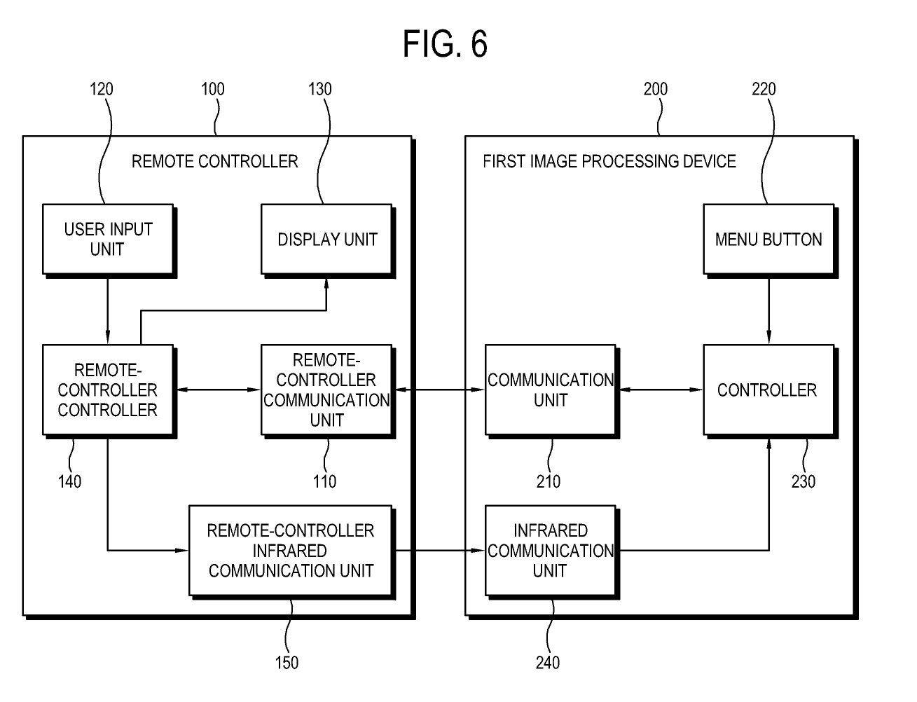

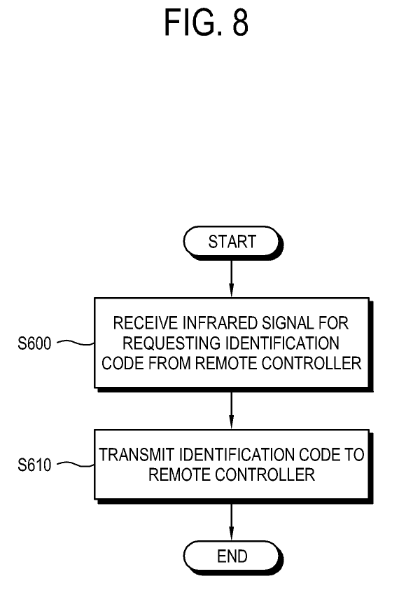

Another method of the remote controller 100 to receive the identification code according to a fourth exemplary embodiment will be described below with reference to FIGS. 6 and 8.

FIG. 6 is a block diagram of a remote controller 100 and a first image processing device 200 according to a fourth exemplary embodiment of the present invention. Plural image processing devices can be applied correspondingly like the first image processing device 200, and thus repetitive descriptions will be avoided.

As shown in FIG. 6, according to the fourth exemplary embodiment of the present invention, the remote controller 100 further includes a remote-controller infrared communication unit 150 which transmits an infrared signal to the first image processing device 200, and the first image processing device 200 further includes an infrared communication unit 240 which receives the infrared signal and transmits an electrical signal corresponding to the infrared signal to the controller 230.

The remote-controller infrared communication unit 150 transmits the infrared signal to the first image processing device 200 under control of the remote-controller controller 140. Contrary to the bi-directional RF communication between the remote-controller communication unit 110 and the communication unit 210, the remote-controller infrared communication unit 150 outputs a one-directional infrared signal.

The remote-controller controller 140 controls the remote-controller infrared communication unit 150 to output the infrared signal to the first image processing device 200, thereby requesting the identification code.

The infrared communication unit 240 receives the infrared signal and outputs an electrical signal corresponding to the infrared signal to the controller 230. Then, the controller 230 controls the communication unit 210 to transmit the the identification code corresponding to identification-code requesting information contained in the infrared signal to the remote controller 100. At this time, the identification code is transmitted and received in the RF method through the communication unit 210 and the remote-controller communication unit 110.

In the case that plural image processing devices receive the infrared signal, the remote controller 100 may receive and store the identification codes transmitted from the image processing devices in sequence, respectively.

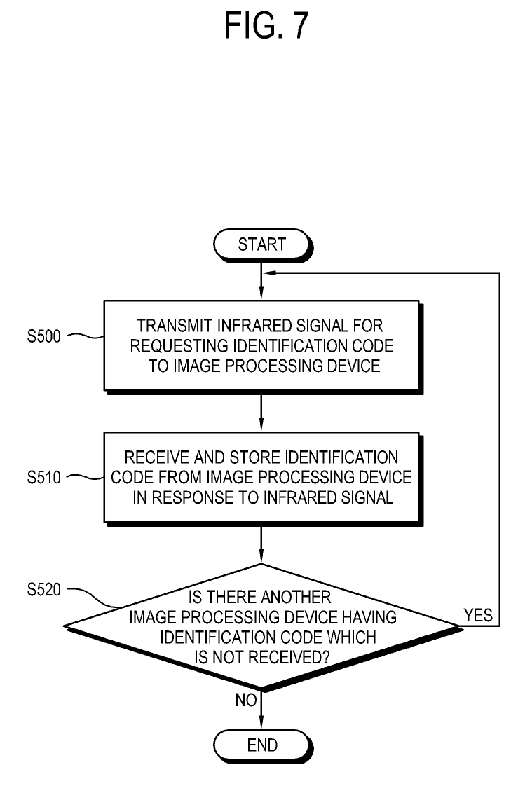

Below, a method of controlling the remote controller 100 and the first image processing device 200 according to the fourth exemplary embodiment of the present invention will be described with reference to FIGS. 7 and 8.

FIG. 7 is a control flowchart of the remote controller 100 according to the fourth exemplary embodiment of the present invention.

As shown in FIG. 7, the remote-controller controller 140 of the remote controller 100 according to the fourth exemplary embodiment controls the remote-controller infrared communication unit 150 to transmit the infrared signal to the first image processing device 200 so as to request the identification code at operation S500. This operation may be implemented as a user sets up to request the identification code through the user input unit 120.

If the first image processing device 200 transmits the identification code in response to receiving the infrared signal, the remote-controller controller 140 receives and stores the identification code at operation S510. At operation S520, it is checked whether there is another image processing device having an identification code which has not been received, and if so, the foregoing processes are repeated if necessary.

FIG. 8 is a control flowchart of the electronic device according to the fourth exemplary embodiment of the present invention.

As shown in FIG. 8, the infrared communication unit 240 of the first image processing device 200 according to the fourth exemplary embodiment receives the infrared signal for requesting the identification code from the remote controller 100 at operation S600. The infrared communication unit 240 sends an electrical signal corresponding to the infrared signal to the controller 230, and the controller 230 controls the communication unit 210 to transmit the identification code to the remote controller 100 in response to the identification code request. Thus, the identification code of the first image processing device 200 can be stored in the remote controller 100.

A configuration of the remote controller 100 to receive the identification code according to a fifth exemplary embodiment will be described with reference to FIGS. 1, 9 and 10. In the fifth exemplary embodiment, the remote controller 100 receives the identification codes from the plurality of image processing devices 200, 300 and 400, but the present invention is not limited to the number of image processing devices.

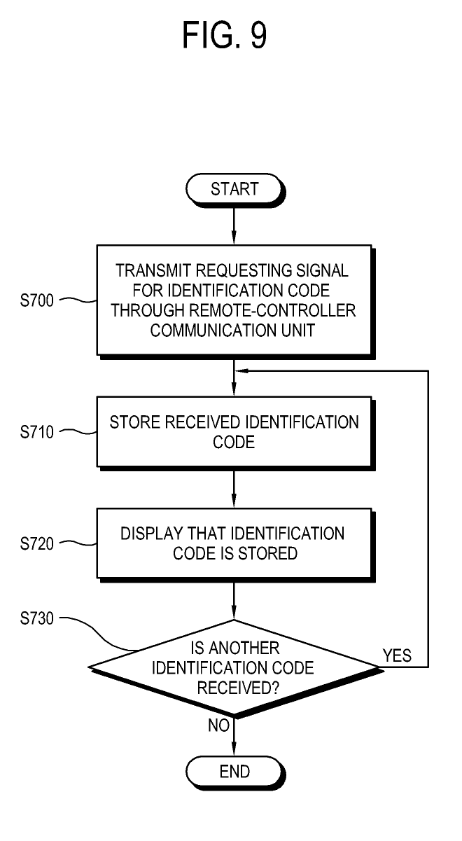

FIG. 9 is a control flowchart of a remote controller according to a fifth exemplary embodiment of the present invention.

As shown in FIG. 9, the remote-controller controller 140 transmits a requesting signal for the identification code through the remote-controller communication unit 110 at operation S700. In this exemplary embodiment, the remote-controller communication unit 110 performs communication based on the RF method, so that the requesting signal for the identification code can be transmitted from the remote-controller communication unit 110 to the communication unit 210 of each image processing device 200, 300, 400 that is placed within a receivable range. Then, each image processing device 200, 300 and 400 transmits the identification code to the remote controller 100 when the communication unit 210 receives the requesting signal for the identification code.

At operation S710, the remote-controller controller 140 stores the identification code when receiving it through the remote-controller communication unit 110. At operation S720, it is displayed that the identification code is stored. At operation S730, it is determined whether another identification code is received. If another identification code is received, the remote-controller controller 140 repeats the above processes and stores a plurality of identification codes in the remote controller 100.

The requesting signal for the identification code, which is transmitted from the remote controller 100 using the RF method, is received by the image processing devices 200, 300 and 400 that perform the communication based on the same RF method. Correspondingly, the remote-controller controller 140 can sequentially process the identification codes received from the image processing devices 200, 300 and 400.

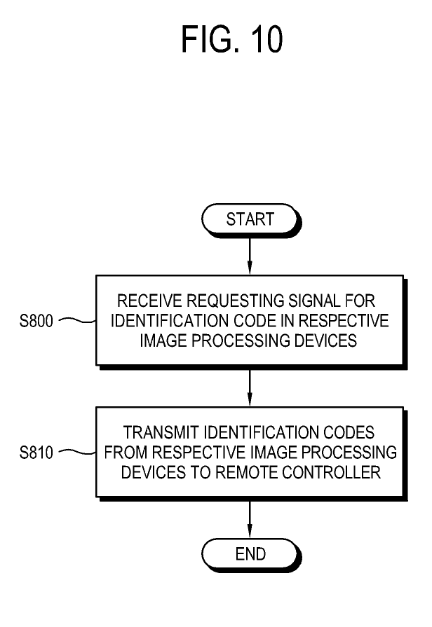

FIG. 10 is a control flowchart of the electronic device 200, 300, 400 according to the fifth exemplary embodiment of the present invention.

As shown in FIG. 10, at operation S800 the requesting signal for the identification code is transmitted from the remote controller 100 to the communication unit 210 of each image processing device 200, 200, 400. Correspondingly, at operation S810 the controller 230 of each image processing device 200, 300, 400 transmits the identification code thereof to the remote controller 100.

Thus, the remote controller 100 transmits the requesting signal for the identification code in the RF method, and receives and stores the identification codes from the image processing devices 200, 300 and 400 placed within a range where the requesting signal is receivable.

As described above, the present invention to provide a remote controller, an electronic device, and a control method thereof, in which each electronic device transmits a corresponding identification code to the remote controller, so that a user can easily store the identification codes without directly finding and inputting the identification codes one by one. Thus, it is possible to control a plurality of electronic devices through one remote controller.

Also, it is convenient for a user to store the corresponding identification codes in the remote controller without separately using a manual that describes the identification codes.

Further, an MAC address of a communication unit provided in an electronic device is used as an identification code corresponding to the electronic device, so that the electronic devices can be differentiated from each other even if there are plural electronic devices of the same model. In addition, there is no need to provide a separate code to an electronic device since the existing MAC address is employed.

Further, an RF method is used for communication between a remote controller and an electronic device, so that the electronic device can transmit an identification code to the remote controller.

Further, a display unit is provided for informing a user that an identification code is stored in a remote controller.

Further, an identification name that allows a user to easily recognize a corresponding electronic device is set up when an identification code is stored in a remote controller, so that the identification name can be displayed when the electronic device corresponding to the identification code is selected. Thus, a user can easily know which one of the electronic devices is selected through the remote controller.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A remote controller for controlling an electronic device, the remote controller comprising:
an input unit;
a communication unit which communicates with at least one electronic device to receive an identification code of the electronic device if a condition for receiving the identification code is satisfied; and
a remote-controller controller which stores the identification code received from the electronic device, and selects the stored identification code so that the electronic device corresponding to the selected identification code is controlled through the input unit.

2. The remote controller according to claim 1, wherein the communication unit receives identification codes from a plurality of electronic devices, respectively, and the controller stores the received identification codes and selects one of the stored identification codes.

3. The remote controller according to claim 2, wherein the input unit selects an electronic device among the plurality of electronic devices corresponding to the stored identification codes, and
the controller controls the electronic device selected by the input unit.

4. The remote controller according to claim 1, wherein the identification code comprises a Media Access Control (MAC) address of the electronic device.

5. The remote controller according to claim 4, wherein the controller determines a model of the electronic device corresponding to the MAC address.

6. The remote controller according to claim 4, wherein the identification code further comprises model information of the electronic device.

7. The remote controller according to claim 1, wherein the communication unit communicates with the electronic device based on a radio frequency (RF) method.

8. The remote controller according to claim 1, wherein the condition for receiving the identification code is satisfied if a preset input for receiving the identification code is performed through the input unit.

9. The remote controller according to claim 1, wherein the condition for receiving the identification code is satisfied if the controller senses that the electronic device outputs a signal having intensity of a preset level or higher.

10. The remote controller according to claim 1, further comprising an infrared communication unit which transmits an infrared signal to the electronic device,
wherein the controller controls the infrared communication unit to transmit a requesting signal for the identification code to the electronic device, and the communication unit receives the identification code corresponding to the requesting signal.

11. The remote controller according to claim 1, wherein the controller controls the communication unit to transmit a requesting signal for the identification code, and the communication unit receives the identification code from the electronic device that receives the requesting signal.

12. The remote controller according to claim 1, further comprising a display unit which displays a notification that the identification code is received and stored.

13. The remote controller according to claim 12, wherein the controller sets an identification name corresponding to the identification code of the electronic device, and controls the display unit to display the identification name if the electronic device is selected by the input unit.

14. The remote controller according to claim 13, wherein the controller controls the display unit to display a message to set the identification name if the identification code is received, and stores the identification name set through the input unit.

15. The remote controller according to claim 12, wherein, if a plurality of identification codes, corresponding to a plurality of electronic devices of a same model, are stored and one of the plurality of identification codes is selected, the controller controls the display unit to display the selected identification code differently from other identification codes.

16. A control method of a remote controller that controls an electronic device, the method comprising:
receiving an identification code from the electronic device if a condition for receiving the identification code is satisfied;
storing the received identification code;
selecting the stored identification code; and
controlling the electronic device corresponding to the selected identification code.

17. The method according to claim 16, wherein the receiving the identification code comprises receiving identification codes from a plurality of electronic devices, respectively,
the storing the identification code comprises storing the plurality of identification codes which are received, and
the controlling the electronic device comprises selecting the identification code among the plurality of stored identification codes.

18. The method according to claim 16, wherein the identification code comprises a Media Access Control (MAC) address of the electronic device.

19. The method according to claim 18, wherein the receiving the identification code comprises determining a model of the electronic device corresponding to the MAC address.

20. The method according to claim 18, wherein the receiving the identification code further comprises receiving model information of the electronic device.

21. The method according to claim 16, wherein the remote controller communicates with the electronic device based on a radio frequency (RF) method.

22. The method according to claim 16, wherein the remote controller comprises an input unit, and
the receiving the identification code comprising:
performing a preset input for receiving the identification code through the input unit; and
receiving the identification code from the electronic device in response to the preset input.

23. The method according to claim 16, wherein the condition for receiving the identification code is satisfied if the remote controller receives a signal having intensity of a preset level or higher.

24. The method according to claim 16, wherein the receiving the identification code comprises:
transmitting a requesting signal for the identification code; and
receiving the identification code corresponding to the requesting signal from at least one electronic device.

25. The method according to claim 24, wherein the transmitting the requesting signal for the identification code comprises transmitting an infrared signal for requesting the identification code.

26. The method according to claim 24, wherein the transmitting the requesting signal for the identification code comprises transmitting the requesting signal using a radio frequency (RF) method.

27. The method according to claim 16, further comprising displaying a notification that the identification code is received and stored.

28. The method according to claim 27, wherein the receiving the identification code further comprises setting an identification name corresponding to the received identification code of the electronic device, and
the controlling the electronic device further comprises displaying the identification name when the stored identification code is selected.

29. The method according to claim 28, wherein the remote controller comprises an input unit, and
the setting the identification name comprises inputting the identification name through the input unit.

30. The method according to claim 16, wherein, if a plurality of identification codes, corresponding to a plurality of electronic devices of a same model, are stored and one of the plurality of identification codes is selected, the controlling the electronic device further comprises displaying the selected identification code differently from other identification codes.

31. An electronic device controlled by a remote controller that outputs a control signal, the electronic device comprising:
a communication unit which communicates with the remote controller; and
a controller which controls the communication unit to transmit an identification code to be stored in the remote controller if a preset condition for transmitting the identification code to the remote controller is satisfied, and controls the electronic device based on a control signal, corresponding to the identification code, output from the remote controller.

32. The electronic device according to claim 31, wherein the electronic device is provided in plural, and each controller of the plural electronic devices transmits the identification code to the remote controller.

33. The electronic device according to claim 31, wherein the identification code comprises a Media Access Control (MAC) address of the communication unit.

34. The electronic device according to claim 33, wherein the identification code further comprises model information of the electronic device.

35. The electronic device according to claim 31, wherein the communication unit communicates with the remote controller using a radio frequency (RF) method.

36. The electronic device according to claim 31, further comprising a menu button for setting the controller to transmit the identification code,
wherein the condition for transmitting the identification code is satisfied if a preset input for transmitting the identification code is performed through the menu button.

37. The electronic device according to claim 31, further comprising an infrared communication unit which receives an infrared signal from the remote controller,
wherein the controller controls the communication unit to transmit the identification code to the remote controller if the infrared signal for requesting the identification code is received.

38. The electronic device according to claim 31, wherein the controller controls the communication unit to transmit the identification code to the remote controller if a requesting signal for the identification code is received from the remote controller.

39. The electronic device according to claim 31, wherein the electronic device comprises at least one of a television, a monitor, a set-top box, a video cassette recorder, a digital versatile disc player, a Blu-ray disc player, and an audio device.

40. A method of controlling an electronic device, the method comprising:
transmitting, from the electronic device, an identification code to be stored in the remote controller if a preset condition for transmitting the identification code from the electronic device to the remote controller is satisfied; and
controlling the electronic device based on a control signal, corresponding to the identification code, received from the remote controller.

41. The method according to claim 40, wherein the transmitting the identification code comprises transmitting identification codes from a plurality of electronic devices to the remote controller.

42. The method according to claim 40, wherein the identification code comprises a Media Access Control (MAC) address of the electronic device.

43. The method according to claim 42, wherein the identification code further comprises model information of the electronic device.

44. The method according to claim 40, wherein communication between the electronic device and the remote controller is performed using a radio frequency (RF) method.

45. The method according to claim 40, wherein the transmitting the identification code further comprises setting the identification code to be transmitted to the remote controller through a menu button provided in the electronic device.

46. The method according to claim 40, wherein the transmitting the identification code comprises:
receiving a requesting signal for the identification code from the remote controller; and
transmitting the identification code to the remote controller.

47. The method according to claim 46, wherein the requesting signal for the identification code comprises an infrared signal.

48. The method according to claim 46, wherein the requesting signal for the identification code comprises a signal based on a radio frequency (RF) method.
